(19) United States
(12) Patent Application Publication
(10) Pub. No.: US 2015/0081471 A1
(43) Pub. Date: Mar. 19, 2015

(54) PERSONAL RECOMMENDATION SCHEME

(71) Applicants: Yu Cheng, Shanghai (CN); Wen-Syan Li, Fremont, CA (US)

(72) Inventors: Yu Cheng, Shanghai (CN); Wen-Syan Li, Fremont, CA (US)

(73) Assignee: SAP AG, Walldorf (DE)

(21) Appl. No.: 14/036,922

(22) Filed: Sep. 25, 2013

(30) Foreign Application Priority Data
Sep. 13, 2013 (CN) 01310418455.0

(51) Int. Cl. G06Q 30/06

(52) U.S. Cl. CPC G06Q 30/0631
USPC 705/26.7

(57) ABSTRACT

A system may include a similarity measurement processing unit configured to determine a plurality of similar users that are similar to a user based on similarity values including calculating the similarity values for pairs of users based on an importance vector and differences between rated items. The importance vector may include importance values corresponding to a plurality of items, and each importance value may represent a similarity importance of a corresponding item. Each similarity value may represent a level of similarity between the user and another user. Also, the system may include a rating processor configured to estimate a rating value of an unrated item for potential recommendation based on recommendations from the plurality of similar users, and provide a recommendation for the item based on the rating value.

### CROSS-REFERENCE TO RELATED APPLICATION

This application claims priority under 35 U.S.C. §119 to Chinese Patent Application 201310418455.0, filed Sep. 13, 2013, titled “PERSONAL RECOMMENDATION SCHEME”, which is incorporated herein by reference in its entirety.

### BACKGROUND

Recently, personal recommendation systems are attracting more and more attention, since it can help users automatically find useful information from a relatively large amount of data. For example, a variety of recommendation algorithms already have been applied in book recommendation websites, movie recommendation websites, and E-commerce, etc. Some conventional recommendation systems include performing a user-similarity evaluation to locate similar users, and then make recommendations for items based on the similar users.

However, these conventional recommendation systems treat all items equally in a user-similarity evaluation. In one conventional approach, the overall difference between a first user's rated items and a second user's rated items is determined. For example, the first user may have rated a first item and a second item, and the second user may have also rated the first item and the second item. A conventional similarity analysis may take the absolute difference between the first user's ratings of the first and second items, and the second user's ratings of the first and second items, and if the sum of the absolute differences is below a certain threshold, the first user and the second user may be identified as similar. Then, a recommendation for an item for the first user may be based on recommendations from the second user. However, this conventional approach does not account for the fact the some items may be more important than other items in assessing the similarity between users.

### SUMMARY

The embodiments provide a system for providing personal recommendations. The system may include at least one processor, and a non-transitory computer-readable storage medium including instructions executable by the at least one processor. The instructions may be configured to implement a similarity measurement processing unit configured to determine a plurality of similar users that are similar to a user based on similarity values including calculating the similarity values for pairs of users based on an importance vector and differences between rated items. The importance vector may include importance values corresponding to a plurality of items, and each importance value may represent a similarity importance of a corresponding item. Each similarity value may represent a level of similarity between the user and another user. Also, the instructions may be configured to implement a rating processor configured to estimate a rating value of an unrated item for potential recommendation based on recommendations from the plurality of similar users, and the rating processing may be configured to provide a recommendation for the item based on the rating value.

The similarity measurement processing unit configured to calculate the similarity values for the pairs of users may include a difference detector configured to calculate an absolute difference between user ratings of the rated items for a pair of the user and the another user, and the similarity measurement processing unit configured to calculate a similarity value for the pair based on the absolute differences and the importance vector may include applying the importance vector to the absolute differences in order to weight the absolute differences.

The similarity measurement processing unit may include an item importance estimator configured to estimate the importance vector, and the item importance estimator may be configured to iteratively update the importance vector.

The similarity measurement processing unit may include a differential evolution (DE) processing unit configured to estimate the importance vector based on DE processing. The DE processing unit configured to estimate the importance vector may include an initialization unit configured to generate initial importance vectors of the items as chromosomes, a first operator unit configured to select a target chromosome and randomly select at least two other chromosomes for each chromosome and generate a donor chromosome for each chromosome based on a processing of the target chromosome and the at least two other chromosomes, a second operator unit configured to determine a trail chromosome based on the target chromosome and the donor chromosome for each chromosome, and an evaluation unit configured to evaluate the target chromosome and the trail chromosome for each chromosome including calculating a fitness of the target chromosome and a fitness of the trail chromosome and updating the chromosomes based on a comparison of the fitness of the target chromosome and the fitness of the trail chromosome. The evaluation unit may be configured to estimate the importance values of the importance vector based on the updated chromosomes.

The rating processor may be configured to estimate the rating value of the unrated item based on a weighted aggregation of the user ratings from the plurality of similar users, and the aggregation may be weighted by the similarity values. The rating processing may be configured to provide the recommendation of the item if the rating value is above a threshold value.

The embodiments may include a non-transitory computer-readable medium storing instructions that when executed cause at least one processor to provide personal recommendations. The instructions may include instructions to determine a plurality of similar users that are similar to a user based on similarity values including calculating the similarity values for pairs of users based on an importance vector and differences between rated items. The importance vector may include importance values corresponding to a plurality of items, and each importance value may represent a similarity importance of a corresponding item. Each similarity value may represent a level of similarity between the user and another user. The instructions may include instructions to estimate a rating value of an unrated item for potential recommendation based on recommendations from the plurality of similar users, and provide a recommendation for the item based on the rating value.

The instructions to calculate the similarity values for the pairs of users may include instructions to calculate an absolute difference between user ratings of the rated items for a pair of the user and the another user, and calculate a similarity value for the pair based on the absolute differences and the importance vector including applying the importance vector to the absolute differences in order to weight the absolute differences.

The instructions may include instructions to estimate the importance vector based iteratively updating the importance vector. Also, the instructions may include instructions to estimate the importance vector based on differential evolution processing.

The instructions to estimate the importance vector based on differential evolution processing may include instructions to generate initial importance vectors of the items as chromosomes, select a target chromosome and randomly select at least two other chromosomes for each chromosome and generate a donor chromosome for each chromosome based on a processing of the target chromosome and the at least two other chromosomes, determine a trail chromosome based on the target chromosome and the donor chromosome for each chromosome, evaluate the target chromosome and the trail chromosome for each chromosome including calculating a fitness of the target chromosome and a fitness of the trail chromosome and update the chromosomes based on a comparison of the fitness of the target chromosome and the fitness of the trail chromosome, and estimate the importance values of the importance vector based on the updated chromosomes.

The instructions to estimate the rating value may include instructions to estimate the rating value of the unrated item based on a weighted aggregation of the user ratings from the plurality of similar users, and the aggregation is weighted by the similarity values. The instruction to provide the recommendation of the item may include instructions to provide the recommendation of the item if the rating value is above a threshold value.

The embodiments may include a computer-implemented method for providing personal recommendations. The method may include determining a plurality of similar users that are similar to a user based on similarity values including calculating the similarity values for pairs of users based on an importance vector and differences between rated items. The importance vector may include importance values corresponding to a plurality of items, and each importance value may represent a similarity importance of a corresponding item. Each similarity value may represent a level of similarity between the user and another user. The method may include estimating a rating value of an unrated item for potential recommendation based on recommendations from the plurality of similar users, and providing a recommendation for the item based on the rating value.

The calculating the similarity values for the pairs of users may include calculating an absolute difference between user ratings of the rated items for a pair of the user and the another user, and calculating a similarity value for the pair based on the absolute differences and the importance vector including applying the importance vector to the absolute differences in order to weight the absolute differences.

The method may include estimating the importance vector based iteratively updating the importance vector. Also, the method may include estimating the importance vector based on differential evolution processing.

The estimating the importance vector based on differential evolution processing may include generating initial importance vectors of the items as chromosomes, selecting a target chromosome and randomly select at least two other chromosomes for each chromosome and generating a donor chromosome for each chromosome based on a processing of the target chromosome and the at least two other chromosomes, determining a trail chromosome based on the target chromosome and the donor chromosome for each chromosome, and evaluating the target chromosome and the trail chromosome for each chromosome including calculating a fitness of the target chromosome and a fitness of the trail chromosome and update the chromosomes based on a comparison of the fitness of the target chromosome and the fitness of the trail chromosome, and estimating the importance values of the importance vector based on the updated chromosomes.

The estimating the rating value may include estimating the rating value of the unrated item based on a weighted aggregation of the user ratings from the plurality of similar users, and the aggregation is weighted by the similarity values.

The details of one or more implementations are set forth in the accompanying drawings and the description below. Other features will be apparent from the description and drawings, and from the claims.

### BRIEF DESCRIPTION OF THE DRAWINGS

FIG. 1 illustrates a system for providing personal recommendations according to an embodiment;

FIG. 2 illustrates a flow chart depicting example operations of the system of FIG. 1 according to an embodiment; and

FIG. 3 illustrates another flow chart depicting example operations of the system of FIG. 1 according to another embodiment.

### DETAILED DESCRIPTION

The embodiments provide a system and method for providing personal recommendations that identifies similar users using an importance vector that weights the items in terms of their level of importance for evaluating whether users are similar to each other. For example, an importance value of a particular item may represent the contribution of that item for the similarity analysis.

In one specific non-limiting example, a first item may relate to a popular movie that receives high scores from users. However, the user rating for the first item may not necessarily contribute to the similarity evaluation between a first user and a second user because the user ratings for the first item are generally the same high values for a large number of users. In contrast, a second item may relate to a special-interest (yet unpopular) movie which receives high scores from a relatively small subset of users. As such, if the first user and the second user also provided high user ratings for the second item, the second item may be relatively more important in evaluating the similarity between the first user and the second user than the first item. Therefore, the importance vector may include an importance value for the second item that is relatively higher than an importance value for the first item.

When evaluating the similarity between the first user and the second user, the system and method may determine the differences between the first user's ratings for the first and second items and the second user's ratings for the first and second items, and weight the difference values (difference vector) using the importance vector in order to obtain a similarity value that accounts for the importance or lack of importance of items (as opposed to treating all of the items equally). The calculated similarity value may represent the similarity between users, e.g., how similar the first user is to the second user. If the similarity value for the second user is within a predefined range (e.g., K-nearest neighbors) of the first user, the second user may be identified as similar to the first user. By identifying similar users in this fashion, the system and method may provide a recommendation for an unrated item (e.g., unrated by the first user) based on the recommendations from the similar users (e.g., the second user). In other words, the preference rate of a user can be estimated by means of recommendations from his/her similar users.

In one example, the importance values of the importance vector may be obtained by an optimization algorithm that estimates the importance values by iteratively updating the importance vectors based on differential evolution (DE) techniques. A DE algorithm is a stochastic real-parameter optimization algorithm. According to the embodiments, the DE-based techniques are utilized to estimate the importance values of the importance vector, e.g. obtain an optimized importance vector. The incorporation of the importance vector into the similarity analysis may lead to more accurate results for recommendations without the need of additional input information to the system. These and other features are further explained with reference to the following figures.

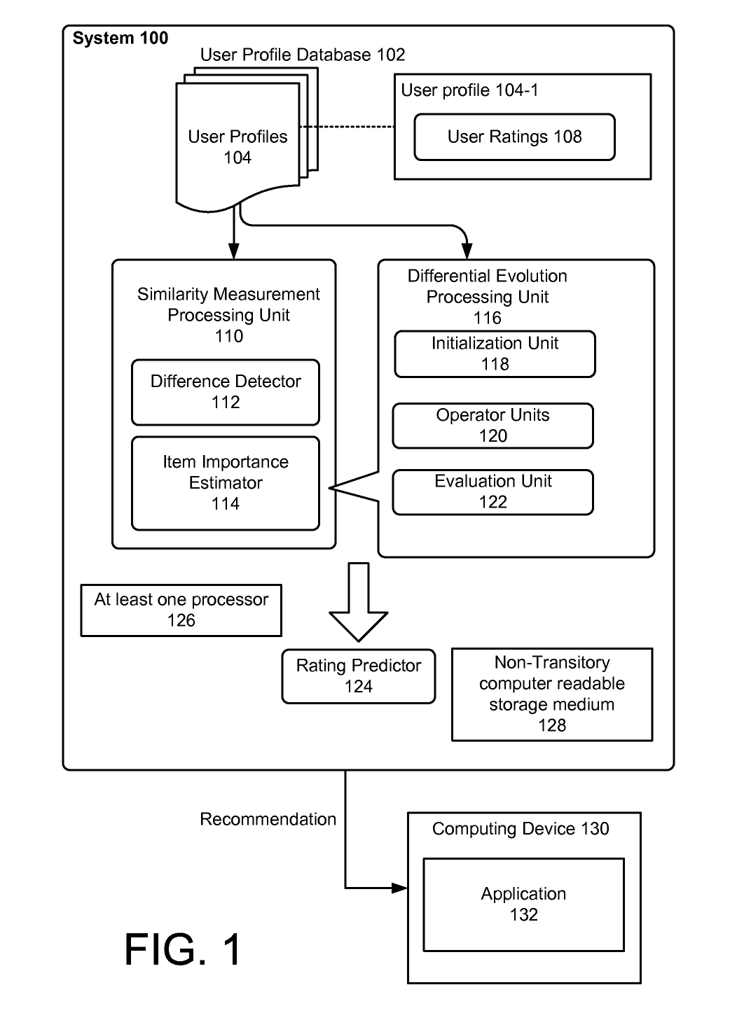

FIG. 1 illustrates a system 100 for providing personal recommendations according to an embodiment. The system 100 may include a user profile database 102 storing a plurality of user profiles 104, a similarity measurement processing unit 110, a differential evolution (DE) processing unit 116, a rating predictor 124, at least one processor 126, and a non-transitory computer-readable medium 128. The system 100 may include other components that are well known to one of ordinary skill in the art for providing personal recommendations. The non-transitory computer readable medium 128 may include instructions, that when executed by the at least one processor 126, are configured to implement the components and/or functionalities of the system 100, as further described below.

The non-transitory computer readable medium 128 may include one or more non-volatile memories, including by way of example semiconductor memory devices, e.g., EPROM, EEPROM, and flash memory devices; magnetic disks, e.g., internal hard disks or removable disks; magneto-optical disks; and CD-ROM and DVD-ROM disks. Besides storing executable instructions, the non-transitory computer-readable medium 128 may also store any type of database structure discussed herein including the user profile database 102 storing the user profiles 104. Alternatively, the user profile database 102 may be associated with a system outside the system 100, and the information associated with the user profiles 104 may be accessed by one or more components of the system 100. The at least one processor 126 may include any type of special purpose logic circuitry, e.g., an FPGA (field programmable gate array) or an ASIC (application-specific integrated circuit).

It is noted that the system 100 may be any type of personal recommendation system that provides recommendations for items to users. For example, the system 100 may recommend an unrated item to a user utilizing the system 100. The unrated item may be an item not rated by the user. However, the system 100 rates the unrated item (e.g., calculates a rating value) based on the recommendations of other users that have been identified as similar. The recommendation may be in the form of identifying one or more items for consideration by the user. The items may be consumer products or services, and may be virtually any type of product or service that may be too numerous to list in detail, but may relate to automobiles, restaurants, books, and/or movies, to name a few examples. Further, the system 100 may provide a mechanism to select or purchase the recommended items, or simply recommend them for subsequent purchase, selection, or consumption. Also, the system 100 may receive user feedback on the items in the form of user ratings. In another example, the system 100 may assign user ratings to the items based on whether the user has purchased or selected the items and/or any other type of feedback from the users.

As shown in FIG. 1, the system 100 may be associated with the user profile database 102 storing the user profiles 104. Each user profile 104 may identify the items that have been rated by the user and the corresponding actual user ratings 108. For example, each user profile 104 may be associated with a particular user, and include the user ratings 108 for the items that have been rated. In one example, the user profiles 104 may include a first user profile 106-1 associated with a particular user, and the first user profile 106-1 may include the user ratings 108 for items that have been rated by that particular user—which may be any number of user ratings 108.

The user rating 108 may be any type of value representing a level of user satisfaction/dissatisfaction. The user rating 108 may be supplied by the user, or assigned by the system 100. In one example, the user rating 108 may be one or more rating levels, e.g., level 1 through level 5. For instance, if the user did not like the item, the user may have provided a rating level of 1. If the user really liked the item, the user may have provided a rating level of 5. In this case, the user rating 108 for the rated item may be information representing the level of satisfaction/dissatisfaction such the rating level of 1 or 5. Also, the user feedback may be one or more rating categories such as strongly dislike, dislike, like, and strongly like, for example. Then, the system 100 may convert the rating category to a numeric value, and store the numeric value as the user rating 108.

Also, each user profile 104 (including the first user profile 104-1) may include other information about the user (e.g., biographic data) and/or additional information regarding the item. For example, each user profile 104 may include preference information indicating certain preferences and user information such as any type of demographical data associated with the user, e.g., age, gender, occupation, etc. Also, the user information may include behavioral or browsing data (e.g., number of visits on the website associated with the system 100) associated with the user, and transactional data such as the number of items that have been rated, total amount spent, and/or products/services purchased, etc.

More generally, the user profile database 102 may be associated with a set of users {1, 2, . . . , U} and a set of items {1, 2, . . . , I}. In one embodiment, the set of items may represent all (or most of) the items handled by the system 100. The users may assign the user ratings 108 to the items. The user ratings 108 (v_{i,j} (i=1, 2, . . . , U, j=1, 2, . . . , I)) may be collected and range from v_low to v_high, such as setting the value v_low=1 for “dislike” and v_high=5 for “like”, in one particular example.

The similarity measurement processing unit 110 may be configured to determine a plurality of users that are similar to a particular user based on the user profile database 102. For example, the similarity measurement processing unit 110 may calculate similarity values for pairs of users based on an importance vector and the information contained in the user profile database 102. With respect to a particular pair of users (e.g., a first user and a second user), a similarity value may represent the similarity between users, e.g., how similar the first user is to the second user. If the similarity value is within a certain predefined range, the first user may be identified as similar to the second user. In one example, the similarity measurement processing unit 110 may calculate the similarity values for the pairs of users using the importance vector and the differences between the user ratings 108 for rated items, as further explained below.

The importance vector may include importance values corresponding to the plurality of items, e.g., the set of items {1, 2, . . . , I}. In one simplified example, the items may include a first item through fifth item—which represent all of the items provided by the system 100. It is understood that the system 100 may be associated with substantially more than five items. A first user may have rated one or more of the five items, and a second user may have also have rated one or more of the five items. Accordingly, the user profile 104 associated with the first user may include the user ratings 108 for one or more of the five items, and the user profile 104 associated with the second user may include the user ratings 108 for one or more of the five items. The importance vector may include an importance value for each of the five items, e.g., [0.39, 0.15, 0.31, 0.59, 0.22], where each entry in the importance vector is associated with an identifier of a corresponding item. For instance, the value 0.39 may be the importance value for the first item, the value 0.15 may be the importance value for the second item, and so on. In one embodiment, the importance vector may provide the importance values for all the items associated with the system 100.

Each importance value may represent a similarity importance of a corresponding item. The similarity importance may represent the contribution of that item for the similarity analysis. In contrast to conventional approaches, the items are not treated equally. Rather, some items may be more important than other for determining whether a pair of users is similar to each other. In one example, the similarity importance of a particular item is greater when that item is not widely associated with a user rating 108 that is the same or similar across a number of users, as further explained below.

In one specific non-limiting example, a first item may relate to a popular movie that receives user ratings 108 from users. However, the user ratings 108 for the first item may not necessarily contribute to the similarity evaluation between a first user and a second user because the user ratings 108 for the first item are generally the same high values for a large number of users. In contrast, a second item may relate to a special-interest (yet unpopular) movie which receives high user ratings 108 from a relatively small subset of users. As such, if the first user and the second user also provided high user ratings 108 for the second item, the second item may be relatively more important in assessing the similarity between the first user and the second user than the first item. Therefore, the importance vector may include an importance value for the second item that is relatively higher than an importance value for the second item.

As further explained below, when evaluating the similarity between a pair of users (e.g. the first user and the second user), the similarity measurement processing unit 110 may determine the differences in the first user's user ratings 108 and the second user's user ratings 108 for each rated item, which may result in a difference vector such as [1, 2, 1, 1, 0]. Then, the similarity measurement processing unit 110 may apply the importance vector to the difference vector in order to weight the difference values in order to obtain a similarity value representing a level of similarity between the first user and the second user.

The weighting of the difference values may account for the varying levels of similarity importance as represented by the importance vector (as opposed to treating all of the items equally). The similarity value may represent the similarity between users, e.g., how similar the first user is to the second user. If the similarity value is above/below a threshold level (or within a predefined range), the first user may be identified as similar to the second user. The similarity measurement processing unit 110 may perform this analysis for a plurality of pairs of users, and then determine which of the users are similar to that user.

In one embodiment, the similarity measurement processing unit 110 may include a difference detector 112, and an item importance estimator 114. The difference detector 112 may be configured to calculate, for each pair of users, an absolute difference between the user ratings 108 for the rated items. Table 1 (provided below) illustrates an example of the operations of the difference detector 112. Table 1 provides the user ratings 108 for the first user and the second user for a plurality of items (e.g., Item 1 to Item 4), and the absolute differences between these user ratings 108.

TABLE 1

| | Item 1 | Item 2 | Item 3 | Item 4 |
|---|---|---|---|---|
| User 1 | 4 | 2 | 5 | 3 |
| User 2 | 5 | 4 | 4 | 3 |
| Absolute | 1 | 2 | 1 | 0 |
| Difference | | | | |

With respect to the items 1-4, the difference detector 112 may calculate the difference in the first user's user ratings 108 and the second user's user ratings 108 for the rated items, which results in the difference vector of [1, 2, 1, 0]. More generally, the difference detector 112 may calculate the absolute difference D(uₚ, u_{q}) between a user pair p and q based on the following equation.

Dⱼ(uₚ, u_{q})=|v_{p,j}−v_{q,j}| Eq. (1):

The item importance estimator 114 may estimate the importance values of the importance vector. The details of the item importance estimator 114 are further explained below. For example, as further explained below, the item importance estimator 114 may incorporate the DE processing unit 116. The DE processing unit 116 may estimate the importance values of the importance vector using a differential evolution algorithm. Generally, the DE processing unit 116 may iteratively update the importance vector based on differential evolution techniques in a manner that optimizes the importance values. However, generally, in one embodiment, the importance vector may be represented as wⱼ (j=1, 2, . . . , I), which is used to weight the rated items and illustrate the importance of each item in similarity evaluation, with respect to all the users. Each value (j) of the importance vector may correspond to a different importance value associated with a corresponding item.

Then, using the importance vector having the estimated importance values, and the difference between the rated items, the similarity measurement processing unit 110 may be configured to calculate the similarity value for the pair. In one example, the similarity measurement processing unit 110 may calculate the similarity value based on the following equation.

S(uₚ, u_{q})=ΣⱼwⱼDⱼ(uₚ, u_{q}) Eq. (2):

The similarity value may represent the similarity between users, e.g., how similar the first user is to the second user. If the similarity value is above/below a threshold level (or within a predefined range), the first user may be identified as similar to the second user. Therefore, based on the calculated similarity values, the similarity measurement processing unit 110 may be configured to select a number of similar users. As further explained below, the recommendations from the users identified as similar to a particular user may be used as a basis to make a recommendation of an unrated item for that particular user.

In one example, the rating predictor 124 may be configured to estimate a rating value of an unrated item based on the recommendations from the plurality of similar users. For example, the rating predictor 124 may receive the similarity values, the importance values, and the differences values, and estimate a rating value for an unrated item to be potential recommended to the user based on these values. In one example, the rating value may be a score computed by the rating predictor 124 that represents the level of confidence for recommending that item. If the rating value is relatively high (or exceed a threshold value), the rating predictor 124 may determine to recommend that item to the user. However, if the rating value is relatively low (or is below a threshold value), the rating predictor 124 may determine to not recommend that item.

The rating predictor 124 may be configured to estimate a rating value of one or more items for a certain user based on the recommendation from the similar user. In one embodiment, the rating predictor 124 may be configured to estimate a rating value of an unrated item j from user i based on a mean (DFM) approach as shown with reference to the following equation.

$${\hat{v}}_{i , j} = {\overline{v}}_{i} + \frac{{\sum }_{k ∈ {U}_{k}} S ( i , k ) \times ( {v}_{k , j} - {\overline{v}}_{k} )}{{\sum }_{k ∈ {U}_{k}} S ( i , k )} \qquad Eq . ( 3 )$$

In this equation, v̅ᵢ denotes a mean value of the i-th user's rating values, Uₖ denotes the k-nearest neighbor users of user i, and \hat{v}_{i,j} is used to indicate the rating value is estimated, rather than a real value. In other words, the rating value of a certain user is estimated in a weighted aggregation approach from all the other k similar users.

The rating predictor 124 may provide the recommendation to a computing device 130 associated with that user. The computing device 130 may be any type of computing device having a processor and memory. In some embodiments, the computing device 130 may be a computer, laptop, smartphone, desktop, smartphone, tablet, or generally any device capable of connecting to the system 100. The computing device 130 may include an application 132 as well as any other commonly known components such as an operating system and network interfaces, for example. The computing device 130 and the system 100 may communicate with each other via any type of known network such as the internet or any type of proprietary networks. The application 132 may be any type of application that interfaces with the system 100. In this context, the application 132 may be hosted on the computing device 130 and interfaces with the system 100 through any type of conventional data transferring techniques. Further, the application 132 may be hosted on the system 100, and the accessed by the computing device 130.

In one embodiment, the rating predictor 124 may provide the recommendation over the network to the computing device 130 so that the user can view the recommendation. In this context, the rating predictor 124 may perform any type of action notifying the user of the recommendation. For example, the recommendation may be emailed, displayed on a display portion of the computing device 130, display of an advertisement, and/or incorporated into an aspect of the application 132.

As indicated above, the item importance estimator 114 is configured to estimate the importance values of the importance vector. In one embodiment, the item important estimator 114 estimates the importance values based on differential evolution (DE). For example, the item importance estimator 114 may be configured to incorporate the DE processing unit 116. The DE processing unit 116 may be configured to estimate the importance values of the importance vector using DE techniques.

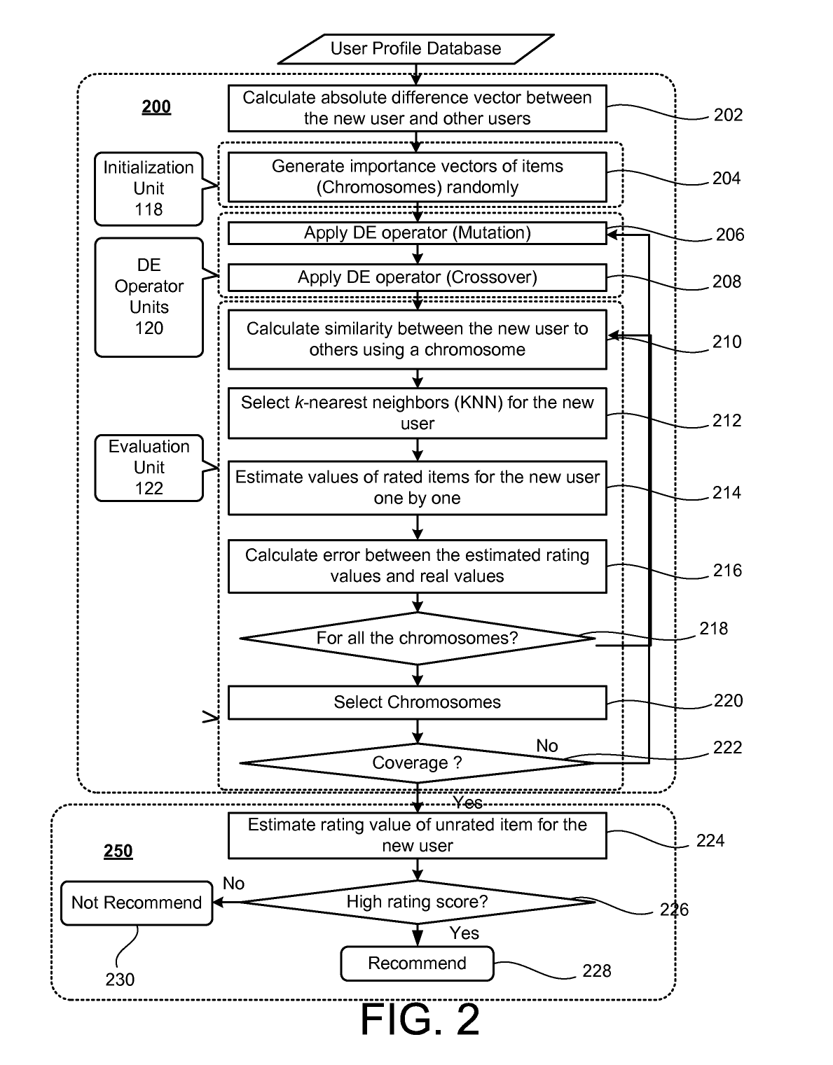

The DE processing unit 116 may include an initialization unit 118, operator units 120 (e.g., a first operator unit 120, a second operator unit 120), and an evaluation unit 122. The details of these units are further described with reference to FIG. 2. However, generally, the initialization unit 118 may be configured to generate initial importance vectors of the items as chromosomes of a population. For each chromosome, the first operator unit 120 may be configured to select a target chromosome and randomly select at least two other chromosomes. Then, the first operator unit 120 may be configured to generate a donor chromosome based on processing of the target chromosome and the at least two other chromosomes. For each chromosome, the second operator unit 120 may be configured to determine a trail chromosome based on the target chromosome and the donor chromosome, where the trail chromosome is a recombination of portions of the target chromosome and the donor chromosome.

For each chromosome, the evaluation unit 122 may be configured to evaluate the target chromosome and the trail chromosome. For example, the evaluation unit 122 may be configured to calculate a fitness of the target chromosome, and a fitness of the trail chromosome. For each chromosome, the evaluation unit 122 may be configured to determine an updated chromosome based on a comparison of the fitness of the target chromosome and the fitness of the trail chromosome. Then, the first operator unit 120, the second operator unit 120, and the evaluation unit 122 are configured to repeat their respective operations for a set number of times or until convergence, and obtain the optimized importance vector based on the processed chromosomes. These and other features relating to the DE-based importance vector optimization are further explained with reference to FIG. 2.

FIG. 2 illustrates a flowchart representing example operations of the system 100 of FIG. 1. Although FIG. 2 is illustrated as a sequential, ordered listing of operations, it will be appreciated that some or all of the operations may occur in a different order, or in parallel, or iteratively, or may overlap in time.

The flowchart of FIG. 2 illustrates the operations of the system 100 of FIG. 1 in further detail. For example, the flowchart of FIG. 2 provides additional details on how the importance vector is optimized using differential evolution. The set of users may be represented as {1, 2, . . . , U} with the user ratings 108 on items as {1, 2, . . . , I}. Generally, as further explained below, the system 100 determines whether or not to recommend a certain item j to a new user u_{new} (or an existing user) if a high rating score \hat{v}ᵤ_{_{new}}_{,j} is predicted based on the user's rating history on other items vᵤ_{_{new}}_{,l} (l≠j) and the similarity evaluation. Essentially, the flow chart of FIG. 2 may be generalized as including two main parts: DE-based importance vector optimization 200 and unrated item estimation 250. The DE-based importance vector optimization 200 is explained below.

An absolute difference vector between the new user and other users may be calculated (202). For example, the difference detector 112 may be configured to calculate an absolute difference between user ratings of the rated items for a pair of the new user and another user. In particular, the difference detector 112 may be configured to calculate a difference between a user rating of a corresponding rated item and a user rating of a corresponding rated item, for each of the rated items. For example, the difference detector 112 may calculate the absolute difference in the same manner described above. It is noted that FIG. 2 is explained with reference to a new user, the embodiments may also encompass an existing user having an unrated item.

Importance vectors (chromosomes) of items may be randomly generated (204). For example, the initialization unit 118 may be configured to generate initial importance vectors of the items as chromosomes of a population. For instance, a plurality of chromosomes may be randomly initialized, and this set of initial chromosomes may be considered the initial generation of chromosomes. Each chromosome may represent an importance vector that will be optimized. In this context, the term chromosome may be synonymous with importance vector. As such, the chromosome may be considered a vector having a series of values corresponding to the items. However, the term chromosome is commonly associated with differential evolution techniques. As such, by applying differential evolution to the optimization of importance vectors, the term chromosome is used to represent an un-optimized importance vector.

Initially, the values of each chromosome may be in the range of v_low to v_high, and may be randomly assigned. As further explained below, each chromosome of the generation may be repeatedly processed such that the values of the chromosomes are updated during each iteration until either the process converges or the number of iterations reaches a threshold level. The processing of a particular chromosome may include applying differential operators (e.g., mutation, cross-over) on the chromosome, evaluating the results of the differential operators, updating the chromosomes, and then determining whether the process has converged, as further explained below.

A DE operator (mutation) may be applied to the chromosomes (206). For example, the first operator unit 120 may perform a mutation operation on the chromosomes of the current generation G (which initially are the chromosomes having the random assigned values). In one example, the mutation operation may include selecting a target chromosome \vec{X}_{T,G} and randomly select at least two other chromosomes from the current generation. Then, the first operator unit 120 may generate a donor chromosome \vec{X}_{D,G} (vector) based on a processing of the target chromosome \vec{X}_{T,G} and the two other chromosomes. The target chromosome \vec{X}_{T,G} may be a parent chromosome (vector) from the current generation G of chromosomes. For example, the first operator unit 120 may perform the mutation operation for each of the chromosomes within the current generation G. As such, the target chromosome \vec{X}_{T,G} may represent the chromosome to be processed, and the other two chromosomes are randomly chosen. The donor chromosome \vec{X}_{D,G} may be considered a mutant vector through the differential mutation operation.

In one embodiment, the first operator unit 120 may be configured to obtain the donor chromosome \vec{X}_{D,G} from the target chromosome \vec{X}_{T,G} and another two randomly selected chromosomes based on the following equation.

\vec{X}_{D,G}=\vec{X}_{T,G}+F·(\vec{X}_{1,G}−\vec{X}_{2,G}) Eq. (4):

The parameter F may be a scalar number. In one example, the parameter F may be set in the interval of [0.4, 1]. Based on this equation, the first operator unit 120 may obtain the donor chromosome \vec{X}_{D,G} for each chromosome in the current generation G.

A subsequent DE operator (crossover) may be applied to the chromosomes (208). For example, for each chromosome in the current generation G, the second operator unit 120 may be configured to perform a cross-over operation on the target chromosome \vec{X}_{T,G} and the donor chromosome \vec{X}_{D,G} to obtain a trail chromosome \vec{X}_{R,G}. Generally, based a processing of variables (e.g., cross-rate, and randomly generated numbers), the second DE operator unit 122 may determine a portion of either the donor chromosome \vec{X}_{D,G} or the target chromosome \vec{X}_{T,G} as the trail chromosome \vec{X}_{R,G}. The trail chromosome \vec{X}_{R,G} may be a new vector based on a recombination of the donor chromosome \vec{X}_{D,G} and the target chromosome \vec{X}_{T,G}. In one embodiment, in order to obtain the trail chromosome, the second operator unit 120 may be configured to perform a binomial crossover based on the following equation.

$${\vec{X}}_{R , G} = \{ \begin{matrix}{X}_{T , j , G} & rand [ 0 , 1 ] < {C}_{r} or j = {j}_{rand} \\ {X}_{D , j , G} & otherwise\end{matrix} \qquad Eq . ( 5 )$$

The parameter rand [0,1] may be a random number between 0 and 1. The variable j_{rand} may be a random integer number between 1 and I (where I is the number of items). The variable X_{T,j,G} may be the j-th item of target vector \vec{X}_{T,G}, and the variable X_{D,j,G} may be the j-th item of donor vector \vec{X}_{D,G}. The parameter Cᵣ may be the cross rate. Basically, the second operator unit 120 may be configured to compare the parameter rand with the cross-rate Cᵣ, and determine if the value j is equal to the variable j_{rand}, and if the cross-rate Cᵣ is greater than parameter rand or the value j is equal to the variable j_{rand}, the second DE operator 120 may be configured to select a portion [j] of the donor chromosome \vec{X}_{D,G} as the trail chromosome trail chromosome \vec{X}_{R,G}. Otherwise, the second operator unit 120 may be configured to select a portion [j] of the target chromosome \vec{X}_{T,G} as the trail chromosome \vec{X}_{R,G}.

An evaluation of the chromosomes may be performed (210, 212, 214, 216, 218, 220, 222). For example, for each chromosome, the evaluation unit 122 may be configured to evaluate the target chromosome \vec{X}_{T,G} and the trail chromosome \vec{X}_{R,G}. Generally, the evaluation unit 122 may be configured to calculate the fitness of the target chromosome \vec{X}_{T,G} and the fitness of the trail chromosome \vec{X}_{R,G}, and select the target chromosome \vec{X}_{T,G} or the trail chromosome \vec{X}_{R,G} as undated chromosome based on a comparison of the fitness of the target chromosome \vec{X}_{T,G} and the fitness of the trail chromosome \vec{X}_{R,G}.

Similarity between the new user and other users may be calculated based on the target chromosome \vec{X}_{T,G} and the trail chromosome \vec{X}_{R,G} (210). For example, the evaluation unit 122 may be configured to separately calculate the similarity between the user and other users using the target chromosome \vec{X}_{T,G} and the trail chromosome \vec{X}_{R,G}. In one embodiment, the evaluation unit 122 may be configured to calculate the similarity values for pairs of user (e.g., each pair including the new user and a different other user) using the target chromosome \vec{X}_{T,G} and the trail chromosome \vec{X}_{R,G} based on Eq. (2) illustrated above.

K-nearest neighbors may be selected based on the similarity values (212). For example, the evaluation unit 122 may be configured to select the similar users among the users using the calculated similarity values. In particular, the evaluation unit 122 may select the users having similarity values within a predefined range, e.g., K-nearest neighbors.

Rating values of rated items for the new user may be estimated (214). For example, the evaluation unit 122 may be configured to calculate the rating values of the items rated by the user according to the target chromosome \vec{X}_{T,G} and the trail chromosome \vec{X}_{R,G}. In one embodiment, the evaluation unit 122 may be configured to calculate both sets of rating values based on Eq. (3).

Error between the estimated rating values and the real values may be calculated (216). For example, for each of rating values for the target chromosome \vec{X}_{T,G} and the trail chromosome \vec{X}_{R,G}, the evaluation unit 122 may be configured to calculate the error between the estimated rating values and the real values. For example, the evaluation unit 122 may be configured to calculate the error for the target chromosome \vec{X}_{T,G} and the error for the trail chromosome \vec{X}_{R,G}. In one embodiment, the evaluation unit 122 may be configured to calculate the error based on the following equation.

$$MAE ( n ) = \frac{{\sum }_{j} \vert {v}_{{u}_{new , j}} - {\hat{v}}_{{u}_{new , j}} \vert}{I} \qquad Eq . ( 6 )$$

The variable vᵤ_{_{new}}_{,j} may denote the rating value of the j-th item for the user, while the parameter \hat{v}ᵤ_{_{new}}_{,j} may denote its estimated value. The parameter I may be the number of items. In one embodiment, the calculated number for the MAE indicates the quality of the chromosome. In one example, if the MAE is relatively small, the MAE may indicate that the chromosome is relatively better. Then, the evaluation unit 122 may be configured to calculate the fitness of the target chromosome \vec{X}_{T,G} and the trail chromosome \vec{X}_{R,G} based on the following equation.

Fitness(n)=−MAE(n). Eq. (7):

A determination is made whether all the chromosomes of the current generation G has been evaluated (218). For example, the evaluation unit 122 may be configured to evaluate each chromosome of the current generation G in the same manner described above. If the evaluation unit 122 determines that not all chromosomes have been evaluated, the process returns to operation 210. However, if all the chromosomes have been evaluated, the process continues to operation 220 discussed below.

Updated chromosomes may be selected (220). For example, based on the calculated error for the target chromosome \vec{X}_{T,G} and the trail chromosome \vec{X}_{R,G} for each of the chromosomes, the evaluation unit 122 may be configured to update each chromosome by selecting either the target chromosome \vec{X}_{T,G} or the trail chromosome \vec{X}_{R,G} as the updated chromosome. For example, for each chromosome, the evaluation unit 122 may be configured to compare the fitness of the target chromosome \vec{X}_{T,G} and the fitness of the trail chromosome \vec{X}_{R,G}, and select the one having the lower fitness value. Then, the evaluation unit 122 may be configured to select the updated chromosomes as the current (or next) generation.

A determination of whether the DE function has converged (222). For example, the evaluation unit 122 may be configured to determine whether the process has converged. For example, if the changes to the chromosomes are minimal (e.g., less than a certain value), the evaluation unit 122 may be configured to determine that the process has converged. If the process has converged, the process continues to the second main portion 250. However, if the process has not converged, the process returns to operation 206. Alternatively, the evaluation unit 122 may determine if the number of iterations has exceeded a threshold number, and if the number of iterations has exceed the threshold number, the process may continue to the second main portion of the process, e.g., 250.

The rating value of the unrated item for the user may be estimated (224). For example, at this point, the importance vector has been optimized based on the DE-based importance vector optimization explained above.

In order to determine the rating value of the unrated item, the similarity measurement processing unit 110 may determine the plurality of similar users based on the optimized importance vector. As explained above, the difference detector 112 may be configured to calculate, for each pair of users, an absolute difference between the user ratings 108 for the rated items. Then, the item importance estimator 114 may obtain the optimized importance vector, and apply the optimized importance vector to the difference vector based on Eq. (2) above in order to obtain the similarity values. The similarity measurement processing unit 110 may select the nearest K users (e.g., identify similar users based on the similarity values being above/below a threshold). Based on these similar users, the rating predictor 124 may compute the rating value for the unrated item. For example, the rating predictor 124 may be configured to calculate the rating value of the unrated item based on Eq. (3).

A determination is made whether the rating value is above a threshold level (226). For example, the rating predictor 124 may be configured to determine whether the rating value is above the threshold level. If the rating predictor 124 determines that the rating value is above the threshold level, a recommendation is provided that recommends the item (228). However, if the rating predictor 124 determines that the rating value is below the threshold level, a recommendation is not provided (230).

In one example, the rating value may be a score computed by the rating predictor 124 that represents the level of confidence for recommending that item. If the rating value is relatively high (or exceed a threshold value), the rating predictor 124 may determine to recommend that item to the user. However, if the rating value is relatively low (or is below a threshold value), the rating predictor 124 may determine to not recommend that item.

For example, the rating predictor 124 may provide the recommendation to the computing device 130 associated with that user. In one embodiment, the rating predictor 124 may provide the recommendation over the network to the computing device 130 so that the user can view the recommendation. In this context, the rating predictor 124 may perform any type of action notifying the user of the recommendation. For example, the recommendation may be emailed, displayed on a display portion of the computing device 130, display of an advertisement, and/or incorporated into an aspect of the application 132.

According to an embodiment, the pseudo code of the DE-based importance vector optimization is provided below.

```
% Optimization based on DE
% NumOfChrom: number of chromosomes (importance vectors) in
DE population
% LenOfIndiv: length of individual (the number of items)
% Population: all the chromosomes of a generation
% F: scalar number for mutation
% CrossRate: crossover rate
% TargetChrom: target chromosome
% DonChrom: donor chromosome
% TrailChrom: trail chromosome
% RandChrom1: Randomly selected chromosome 1
% RandChrom2: Randomly selected chromosome 2
FUNCTION OPTIMIZATION
BEGIN
% ============ Initialization============
Initialize NumOfChrom chromosomes as Population randomly
% ============ End Initialization ========
WHILE not converge
FOR EACH chromosome IN Population
    % ============Mutation============
    TargetChrom = Chromosome
    Randomly select RandChrom1 and RandChrom2 from population
besides TargetChrom
    DonChrom = TargetChrom + F*(RandChrom1 − RandChrom2)
    % ===========End Mutation===========
    % ============ Crossover=============
    FOR j = 1 : LenOfIndiv
      Rand = Randomly generate a real number in [0,1]
      j_{rand} = Randomly generate an integer number in [1, LenOfIndiv]
      IF (Rand < CrosRate) OR (j = j_{rand})
        TrailChrom[j] = DonChrom[j]
      ELSE
        TrailChrom[j] = TargetChrom[j]
      ENDIF
    ENDFOR
    % ===========End Crossover============
    % =============Selection=============
    Evaluate both the TargetChrom and TrailChrom by Eq. (3) and (4)
    IF Fitness(TargetChrom) ≦ Fitness(TrailChrom)
      Chromosome = TrailChrom
    ELSE
      Chromosome = TargetChrom
    ENDIF
    % =============End Selection============
  END FOR EACH
  Update Chromosomes as the next generation
END WHILE
END BEGIN
```

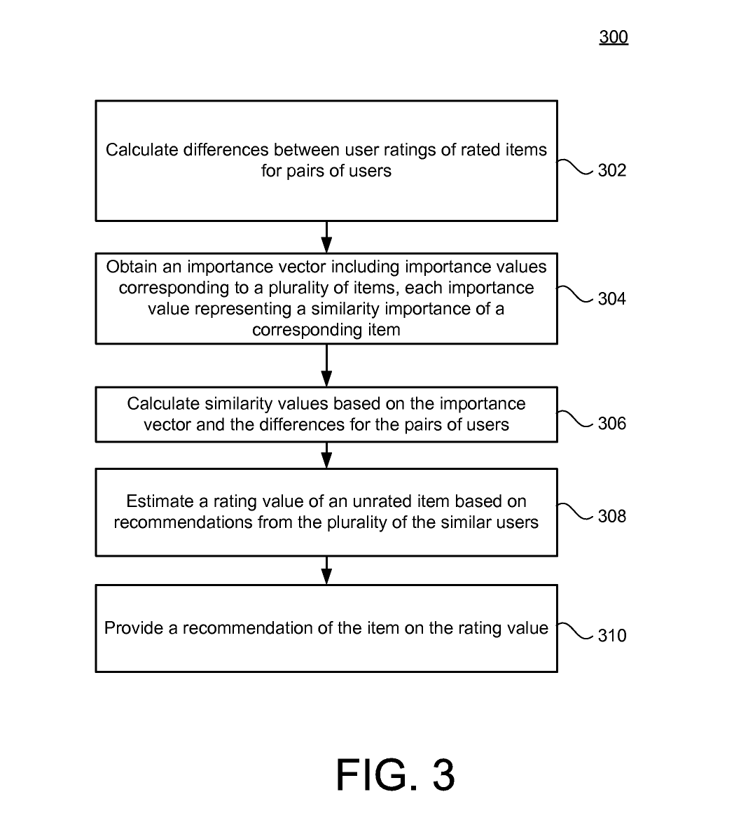

FIG. 3 illustrates a flowchart representing example operations of the system 100 of FIG. 1. Although FIG. 3 is illustrated as a sequential, ordered listing of operations, it will be appreciated that some or all of the operations may occur in a different order, or in parallel, or iteratively, or may overlap in time.

Differences between user ratings of rated items for pairs of users may be calculated (302). For example, the difference detector 112 may be configured to calculate, for each pair of users, an absolute difference between the user ratings 108 for the rated items, which may be based on Eq. (1).

An importance vector including importance values corresponding to a plurality of items may be obtained, where each importance value represents a similarity importance of a corresponding item (304). For example, the item importance estimator 114 may obtain the importance vector. In one embodiment, the importance vector may have already been optimized based on the DE techniques. The optimization of the importance vector is further detailed with respect to FIG. 2.

Similarity values may be calculated based on the importance vector and the differences for the pairs of users (308). For example, using the importance vector having the estimated importance values, and the difference between the rated items, the similarity measurement processing unit 110 may be configured to calculate the similarity value for the pair. In one example, the similarity measurement processing unit 110 may calculate the similarity value based on Eq. (2). The similarity value may represent the similarity between users, e.g., how similar the first user is to the second user. If the similarity value is above/below a threshold level (or within a predefined range), the first user may be identified as similar to the second user. Therefore, based on the calculated similarity values, the similarity measurement processing unit 110 may be configured to select a number of similar users. As further explained below, the recommendations from the users identified as similar to a particular user may be used as a basis to make a recommendation of an unrated item for that particular user

A rating value for an unrated item may be estimated based on recommendations from the plurality of similar users (308). For example, the rating predictor 124 may be configured to estimate a rating value of an unrated item based on the recommendations from the plurality of similar users. For example, the rating predictor 124 may receive the similarity values, the importance values, and the differences values, and estimate a rating value for an unrated item to be potential recommended to the user based on these values. In one embodiment, the rating predictor 124 may be configured to estimate the rating value based on Eq. (3).

A recommendation of the item may be provided based on the rating value (310). For example, if the rating value is relatively high (or exceed a threshold value), the rating predictor 124 may determine to recommend that item to the user. However, if the rating value is relatively low (or is below a threshold value), the rating predictor 124 may determine to not recommend that item. In one embodiment, the rating predictor 124 may provide the recommendation over the network to the computing device 130 so that the user can view the recommendation. In this context, the rating predictor 124 may perform any type of action notifying the user of the recommendation. For example, the recommendation may be emailed, displayed on a display portion of the computing device 130, display of an advertisement, and/or incorporated into an aspect of the application 132.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system for providing personal recommendations, the system comprising:
at least one processor;
a non-transitory computer-readable storage medium including instructions executable by the at least one processor, the instructions configured to implement,
a similarity measurement processing unit configured to determine a plurality of similar users that are similar to a user based on similarity values including calculating the similarity values for pairs of users based on an importance vector and differences between rated items, the importance vector including importance values corresponding to a plurality of items, each importance value representing a similarity importance of a corresponding item, each similarity value representing a level of similarity between the user and another user; and
a rating processor configured to estimate a rating value of an unrated item for potential recommendation based on recommendations from the plurality of similar users, the rating processing configured to provide a recommendation for the item based on the rating value.

2. The system of claim 1, wherein the similarity measurement processing unit configured to calculate the similarity values for the pairs of users includes:
a difference detector configured to calculate an absolute difference between user ratings of the rated items for a pair of the user and the another user,
wherein the similarity measurement processing unit is configured to calculate a similarity value for the pair based on the absolute differences and the importance vector including applying the importance vector to the absolute differences in order to weight the absolute differences.

3. The system of claim 1, wherein the similarity measurement processing unit includes an item importance estimator configured to estimate the importance vector, the item importance estimator configured to iteratively update the importance vector.

4. The system of claim 1, wherein the similarity measurement processing unit includes a differential evolution (DE) processing unit configured to estimate the importance vector based on DE processing.

5. The system of claim 4, wherein the DE processing unit configured to estimate the importance vector includes:
an initialization unit configured to generate initial importance vectors of the items as chromosomes;
a first operator unit configured to select a target chromosome and randomly select at least two other chromosomes for each chromosome, and generate a donor chromosome for each chromosome based on a processing of the target chromosome and the at least two other chromosomes;
a second operator unit configured to determine a trail chromosome based on the target chromosome and the donor chromosome for each chromosome;
an evaluation unit configured to evaluate the target chromosome and the trail chromosome for each chromosome including calculating a fitness of the target chromosome and a fitness of the trail chromosome and updating the chromosomes based on a comparison of the fitness of the target chromosome and the fitness of the trail chromosome, wherein the evaluation unit is configured to estimate the importance values of the importance vector based on the updated chromosomes.

6. The system of claim 1, wherein the rating processor configured to estimate the rating value of the unrated item based on a weighted aggregation of the user ratings from the plurality of similar users, and the aggregation is weighted by the similarity values.

7. The system of claim 1, wherein the rating processing configured to provide the recommendation of the item if the rating value is above a threshold value.

8. A non-transitory computer-readable medium storing instructions that when executed cause at least one processor to provide personal recommendations, the instructions comprising instructions to:
determine a plurality of similar users that are similar to a user based on similarity values including calculating the similarity values for pairs of users based on an importance vector and differences between rated items, the importance vector including importance values corresponding to a plurality of items, each importance value representing a similarity importance of a corresponding item, each similarity value representing a level of similarity between the user and another user;
estimate a rating value of an unrated item for potential recommendation based on recommendations from the plurality of similar users; and
provide a recommendation for the item based on the rating value.

9. The non-transitory computer-readable medium of claim 8, wherein the instructions to calculate the similarity values for the pairs of users include instructions to:
calculate an absolute difference between user ratings of the rated items for a pair of the user and the another user; and
calculate a similarity value for the pair based on the absolute differences and the importance vector including applying the importance vector to the absolute differences in order to weight the absolute differences.

10. The non-transitory computer-readable medium of claim 8, wherein the instructions include instructions to:
estimate the importance vector based iteratively updating the importance vector.

11. The non-transitory computer-readable medium of claim 8, wherein the instructions include instructions to:
estimate the importance vector based on differential evolution processing.

12. The non-transitory computer-readable medium of claim 11, wherein the instructions to estimate the importance vector based on differential evolution processing includes:
generate initial importance vectors of the items as chromosomes;
select a target chromosome and randomly select at least two other chromosomes for each chromosome and generate a donor chromosome for each chromosome based on a processing of the target chromosome and the at least two other chromosomes;
determine a trail chromosome based on the target chromosome and the donor chromosome for each chromosome;
evaluate the target chromosome and the trail chromosome for each chromosome including calculating a fitness of the target chromosome and a fitness of the trail chromosome and update the chromosomes based on a comparison of the fitness of the target chromosome and the fitness of the trail chromosome; and
estimate the importance values of the importance vector based on the updated chromosomes.

13. The non-transitory computer-readable medium of claim 8, wherein the instructions to estimate the rating value include instructions to:
estimate the rating value of the unrated item based on a weighted aggregation of the user ratings from the plurality of similar users, and the aggregation is weighted by the similarity values.

14. The non-transitory computer-readable medium of claim 8, wherein the instruction to provide the recommendation of the item include instructions to provide the recommendation of the item if the rating value is above a threshold value.

15. A computer-implemented method for providing personal recommendations, the method comprising:
determining a plurality of similar users that are similar to a user based on similarity values including calculating the similarity values for pairs of users based on an importance vector and differences between rated items, the importance vector including importance values corresponding to a plurality of items, each importance value representing a similarity importance of a corresponding item, each similarity value representing a level of similarity between the user and another user;
estimating a rating value of an unrated item for potential recommendation based on recommendations from the plurality of similar users; and
providing a recommendation for the item based on the rating value.

16. The computer-implemented method of claim 15, wherein the calculating the similarity values for the pairs of users includes:
calculating an absolute difference between user ratings of the rated items for a pair of the user and the another user; and
calculating a similarity value for the pair based on the absolute differences and the importance vector including applying the importance vector to the absolute differences in order to weight the absolute differences.

17. The computer-implemented method of claim 15, further comprising:
estimating the importance vector based iteratively updating the importance vector.

18. The computer-implemented method of claim 15, further comprising:
estimating the importance vector based on differential evolution processing.

19. The computer-implemented method of claim 18, wherein the estimating the importance vector based on differential evolution processing includes:
generating initial importance vectors of the items as chromosomes;
selecting a target chromosome and randomly select at least two other chromosomes for each chromosome and generating a donor chromosome for each chromosome based on a processing of the target chromosome and the at least two other chromosomes;
determining a trail chromosome based on the target chromosome and the donor chromosome for each chromosome;
evaluating the target chromosome and the trail chromosome for each chromosome including calculating a fitness of the target chromosome and a fitness of the trail chromosome and update the chromosomes based on a comparison of the fitness of the target chromosome and the fitness of the trail chromosome; and
estimating the importance values of the importance vector based on the updated chromosomes.

20. The computer-implemented method of claim 15, wherein the estimating the rating value includes:
estimating the rating value of the unrated item based on a weighted aggregation of the user ratings from the plurality of similar users, and the aggregation is weighted by the similarity values.
